(19) United States
(12) Patent Application Publication
(10) Pub. No.: US 2025/0368402 A1
(43) Pub. Date: Dec. 4, 2025

(54) AIRLESS PAINT SPRAYER LID AND PAINT BUCKET

(71) Applicant: Robert Roman, Las Vegas, NV (US)

(72) Inventor: Robert Roman, Las Vegas, NV (US)

(21) Appl. No.: 18/732,359

(22) Filed: Jun. 3, 2024

(51) Int. Cl. B65D 47/12; B05B 9/04; B05B 15/40; B44D 3/12; B65D 47/32

(52) U.S. Cl. CPC B65D 47/122; B05B 9/0403; B05B 15/40; B44D 3/127; B65D 47/32

(57) ABSTRACT

A paint sprayer system includes a bucket lid three smaller openings and a fourth larger opening. One smaller opening is to receive a primer unit and another smaller opening is to receive a suction unit while the third smaller opening serves as an air vent. The larger opening is used to add paint to the bucket as needed. The system further includes stoppers, locking rings and caps. In practice, the stoppers and locking rings are used to insulate, seal and/or cover openings in the bucket lid and secure the primer unit and suction unit in the bucket. The paint sprayer system as described reduces or eliminates debris from the paint and further prevents paint from drying in the bucket. The paint sprayer system also eliminates much of the daily cleaning associated with conventional paint sprayer systems.

### FIELD OF THE INVENTION

The embodiments of the present invention relate to a modified paint bucket lid for use with an airless paint sprayer.

### BACKGROUND

Commercial paint sprayers are configured to remove paint from 5 gallon buckets using pumps and hoses. The paint sprayers include a primer unit and suction unit which are both positioned in the paint bucket to move the paint from the paint bucket through the paint sprayer and sprayed onto a surface being painted. Several issues arise from the conventional system including debris falling into the uncovered paint bucket and the paint drying. Debris and dried paint can clog the paint sprayer and/or mix with the paint causing the painted surface to include undesired bumps and imperfections. Due to the filters within the paint sprayer, debris or globs of paint cannot make it through the sprayer onto the surface to be painted. Instead, the filters become clogged, and the sprayer stops working. To continue operating, the sprayer filter must be removed and cleaned prior to continued use.

It would be advantageous to develop an easy-to-use, universal system to reduce or eliminate debris from falling into a paint bucket and paint from drying in the paint bucket.

### SUMMARY

The embodiments of the present invention broadly involve a paint bucket lid including four openings. Three of the openings are generally equal in size while the fourth opening is larger. One of the three smaller openings is to receive a primer unit and one of the three smaller opening is to receive a suction unit while the third smaller opening serves as an air vent. The larger opening is used to add paint to the bucket. The system further includes split rubber stoppers, locking rings and caps. In practice, the split rubber stoppers and locking rings are used to insulate, seal and/or cover openings in the bucket and secure the primer unit and suction unit in the bucket of paint.

Using the system generally involves: (i) inserting a strainer bag in the bucket; (ii) attaching the modified lid, with the four openings, to the bucket; (iii) positioning locking rings and split rubber stoppers on the primer and suction units; (iv) inserting the primer and suction units into respective openings in the lid and (thru) an opening in the strainer bag; (v) inserting split rubber stoppers into the openings receiving the primer and suction units; (vi) securing locking rings onto raised rims about the openings receiving the primer and suction units; (vii) if needed, adding paint to the bucket; (viii) placing a lid on the large opening through which paint is added and (iv) adding a rubber stopper and cap to the third smaller opening.

As referenced above and described in detail below, the bucket lid prevents debris from falling into the bucket and contaminating the paint and prevents the contained paint from drying. Moreover, covering the third opening with a lid permits the paint sprayer, bucket with lid and contained paint to sit overnight without the need to clean the system and reassemble it daily.

Other variations, embodiments and features of the present invention will become evident from the following detailed description, drawings and claims.

### BRIEF DESCRIPTION OF THE DRAWINGS

FIG. 1 illustrates a prior art commercial paint sprayer of the type compatible with the embodiments of the present invention;

FIGS. 2A and 2B illustrate a first prior art methodology for attempting to prevent debris from falling into a paint bucket and paint drying in the bucket;

FIG. 3 illustrates a second prior art methodology for attempting to prevent debris from falling into a paint bucket and paint drying in the bucket;

FIG. 4 illustrates a third prior art methodology for attempting to prevent debris from falling into a paint bucket and paint drying in the bucket;

FIG. 5 illustrates a fourth prior art methodology for attempting to prevent debris from falling into a paint bucket and paint drying in the bucket;

FIG. 6 illustrates a first step in assembling the paint sprayer system according to the embodiments of the present invention;

FIG. 7 illustrates a second step in assembling the paint sprayer system according to the embodiments of the present invention;

FIG. 8 illustrates a third step in assembling the paint sprayer system according to the embodiments of the present invention;

FIG. 9 illustrates a fourth step in assembling the paint sprayer system according to the embodiments of the present invention;

FIG. 10 illustrates a fifth step in assembling the paint sprayer system according to the embodiments of the present invention;

FIG. 11 illustrates a sixth step in assembling the paint sprayer system according to the embodiments of the present invention;

FIG. 12 illustrates a seventh step in assembling the paint sprayer system according to the embodiments of the present invention;

FIG. 13 illustrates a perspective top down view of the paint bucket system according to the embodiments of the present invention;

FIG. 14 illustrates parts of a modified bucket lid according to the embodiments of the present invention; and

FIG. 15 illustrates a flow chart for fabricating and assembling the paint sprayer system according to the embodiments of the present invention.

### DETAILED DESCRIPTION

For the purposes of promoting an understanding of the principles in accordance with the embodiments of the present invention, reference will now be made to the embodiments illustrated in the drawings and specific language will be used to describe the same. It will nevertheless be understood that no limitation of the scope of the invention is thereby intended. Any alterations and further modifications of the inventive feature illustrated herein, and any additional applications of the principles of the invention as illustrated herein, which would normally occur to one skilled in the relevant art and having possession of this disclosure, are to be considered within the scope of the invention claimed.

Those skilled in the art will recognize that the components described herein may be fabricated using any known techniques and may be fabricated of any available materials suitable for the desired task. Those skilled in the art will recognize that the airless paint sprayer system may be fabricated using off-the-shelf parts available at most hardware stores. In one embodiment, the parts and components necessary to fabricate the airless paint sprayer system of the embodiments of the present invention may be sold as a kit. In other embodiments, the airless paint sprayer system of the embodiments of the present invention may be purchased in assembled form whereby a manufacturer uses customized parts or a combination of customized parts and off-the-shelf parts to fabricate the same.

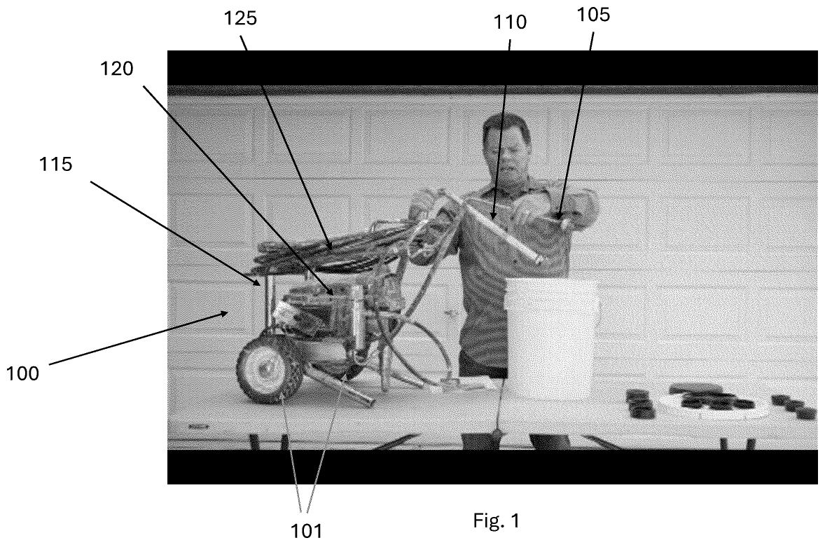

FIG. 1 shows a prior art mobile paint sprayer 100. The paint sprayer 100 is made mobile by a pair of wheels 101. Other suitable paint sprayers may not incorporate wheels. The paint sprayer 100 includes a primer unit 105, suction unit 110, frame 115, motor/pump 120 and paint application hose 125.

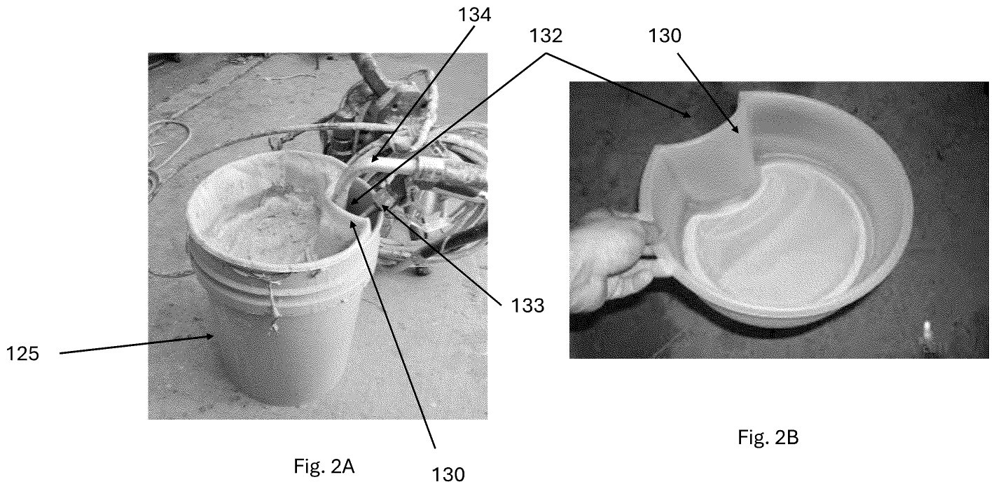

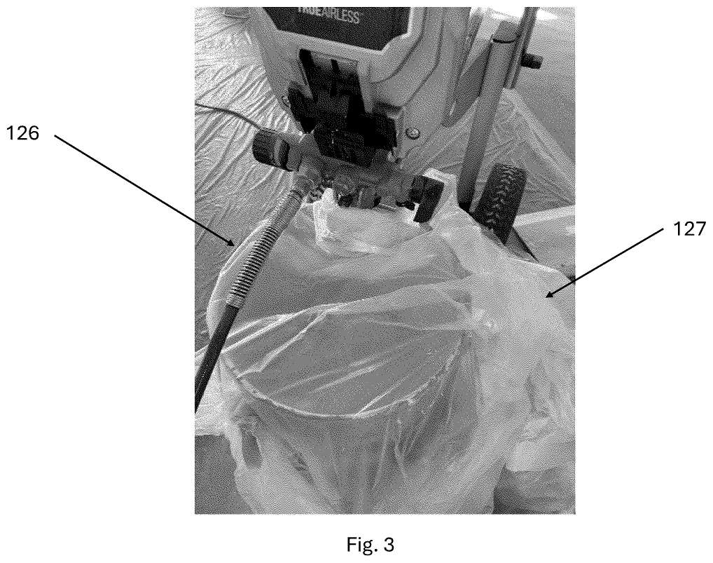

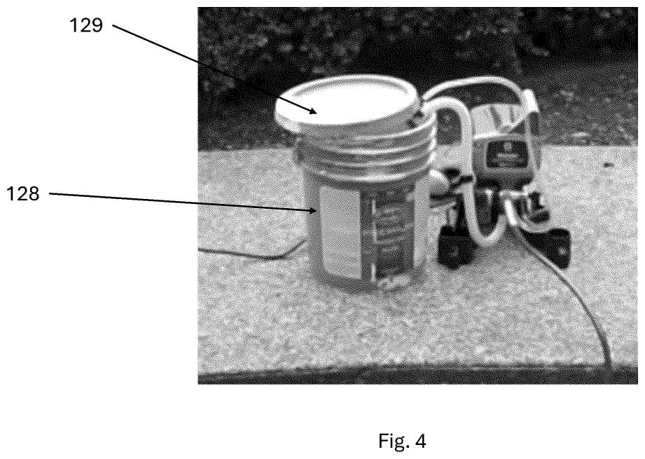

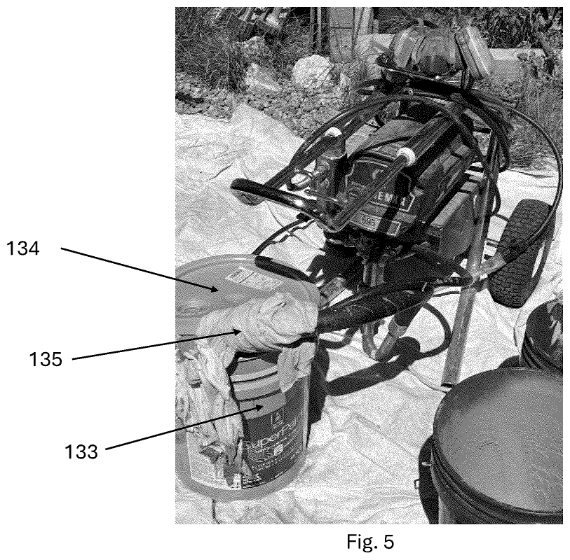

FIGS. 2 through 5 show on-site prior art attempts to prevent debris from falling into a paint bucket and paint drying in the bucket. FIG. 2A shows a paint bucket 125 with a plastic strainer 130 (shown in FIG. 2B) fitted into the bucket opening. With this arrangement, paint is poured through the strainer 130 which keeps debris from falling into the paint. A concave edge 132 allows a primer unit 133 and suction unit 134 to be positioned in the paint below the strainer 130. This arrangement does not prevent the paint from drying and clogging the strainer 130. FIG. 3 shows a bucket 126 with a plastic tarp 127 covering the opening of the bucket 126 and permitting a primer unit and suction unit to be positioned in the contained paint. While the plastic tarp 127 effectively prevents debris from falling into the paint, the tarp 127 does not prevent the paint from drying. Moreover, the plastic tarp 127 needs to be removed each time paint is added to the bucket 126. FIG. 4 shows a bucket 128 with a lid 129 balanced over opening of the bucket 128 and permitting a primer unit and suction unit to be positioned in the contained paint. Like the plastic tarp 127, the lid 129 effectively prevents debris from falling into the paint, the lid 129 does not prevent the paint from drying. FIG. 5 shows a bucket 133 with a lid 134 partially pried open permitting a primer unit and suction unit to be positioned in the contained paint. Rags 135 are used to cover any gap between a primer unit and suction unit, and the lid 134. While the lid 134 effectively prevents debris from falling into the paint, the lid 134 does not prevent the paint from drying and the lid 134 needs to be removed each time paint is added to the bucket 133.

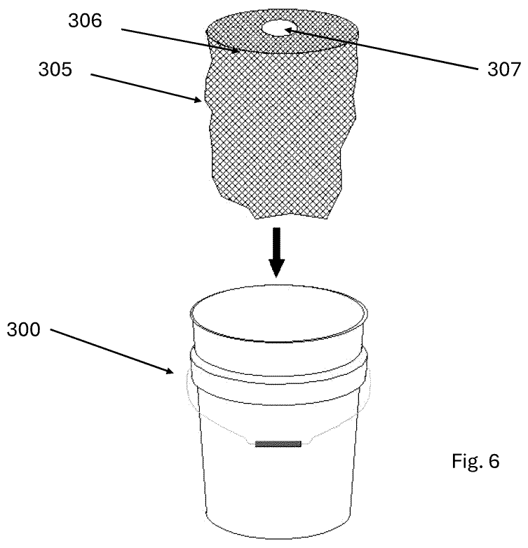

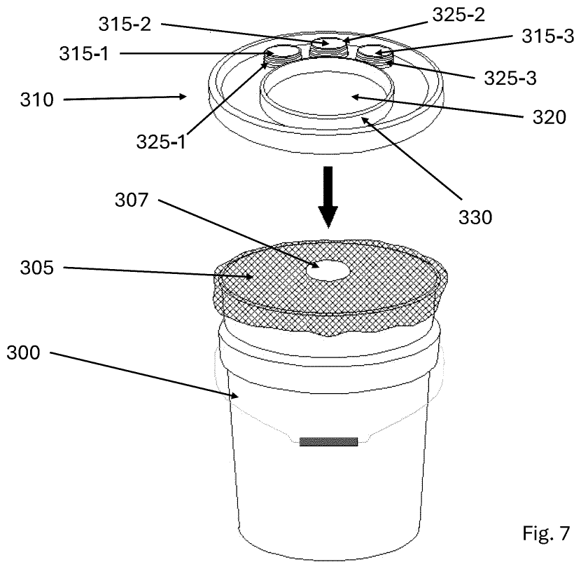

FIGS. 6 through 12 show various steps associated with assembling the paint sprayer system according to the embodiments of the present invention. FIG. 6 shows a bucket 300 receiving a strainer bag 305. The strainer bag 305 includes an elastic band 306 allowing the strainer bag 305 to be secured to an upper edge of the bucket opening (as best seen in FIG. 7). An opening 307 in the strainer bag 305 permits a primer unit and suction unit to be positioned in the contained paint. FIG. 7 shows the strainer bag 305 attached, via the elastic band 306, to an upper edge of the bucket opening. Next, a bucket lid 310 is attached over the bucket opening. The bucket lid 310, includes three similarly-sized smaller openings 315-1 through 315-3 and a larger paint pour opening 320. Those skilled in the art will recognize that the sizes of each of the openings 315-1 through 315-3 and 320 are dictated by a purpose and thus may be smaller or larger as needed.

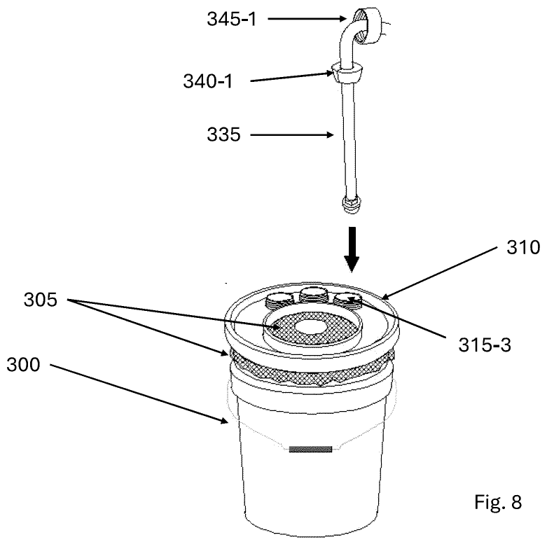

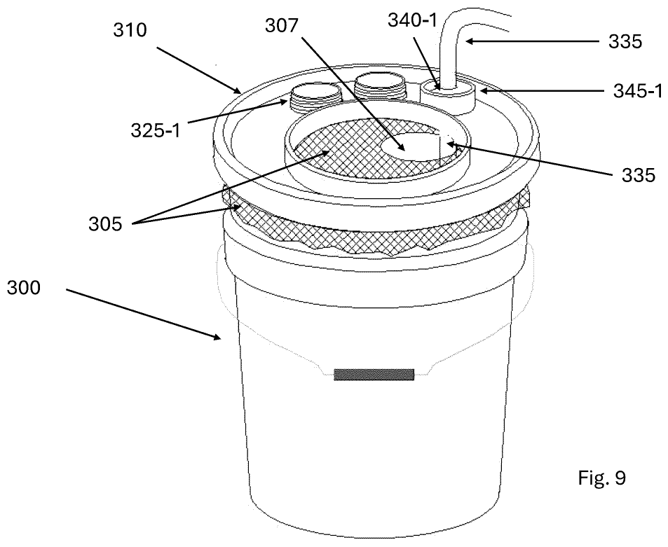

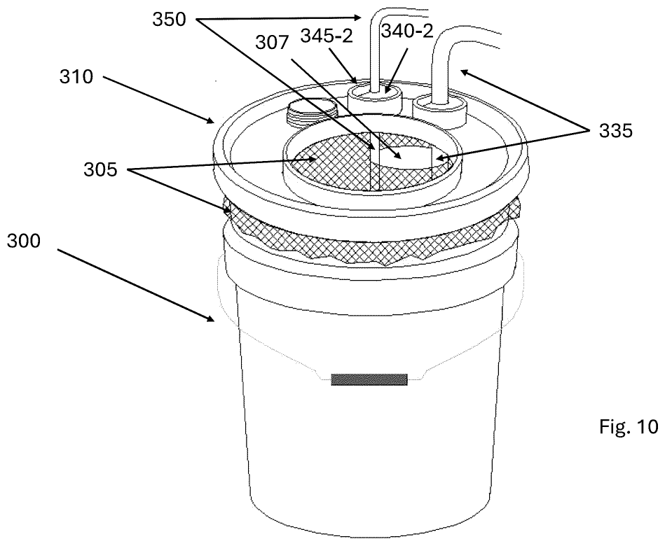

Still referring to FIG. 7, each opening 315-1 through 315-3 and 320 is circumscribed by a raised rim 325-1 through 325-3 and 330, respectively. As shown, rims 325-1 through 325-3 are threaded for reasons detailed below. FIG. 8 shows bucket lid 310 attached to the bucket 300 over the strainer bag 305. Next, a suction unit 335 extending from the paint sprayer (not visible) is inserted into opening 315-3. A split rubber stopper 340-1 and locking ring 345-1 are shown after being positioned on the suction unit 335. FIG. 9 shows the suction unit 335 inserted through opening 315-3 in the bucket lid 310 with a locking ring 345-1 threaded onto the raised rim 325-3. The split rubber stopper 340-1 insulates the opening 315-3. The suction unit 335 is also inserted through the opening 307 in the strainer bag 305 to prevent the strainer bag 305 from being ingested into the suction unit 335 with paint. FIG. 10 shows a primer unit 350 inserted through opening 315-2 in the bucket lid 310 with a locking ring 345-2 threaded onto the raised rim 325-2. The split rubber stopper 340-2 insulates the opening 325-2. The primer unit 350 is also inserted through the opening 307 in the strainer bag 305 to prevent the strainer bag 305 from interfering with the action of the primer unit 350 in the paint.

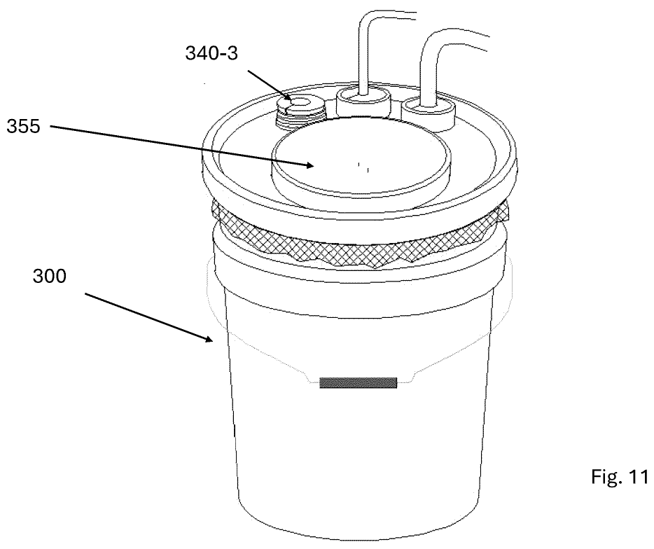

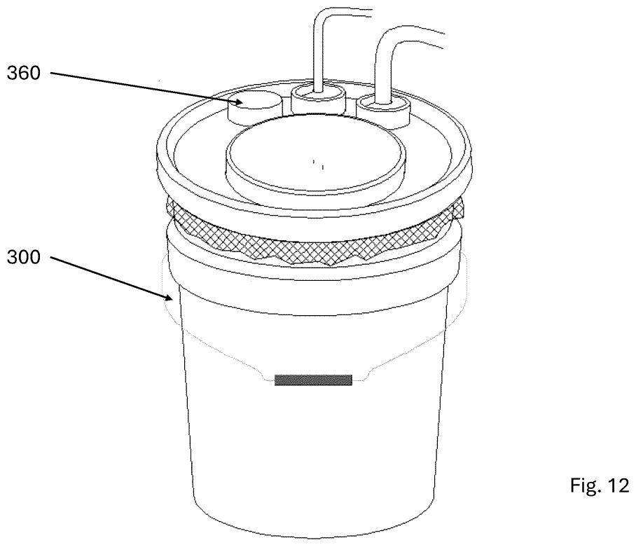

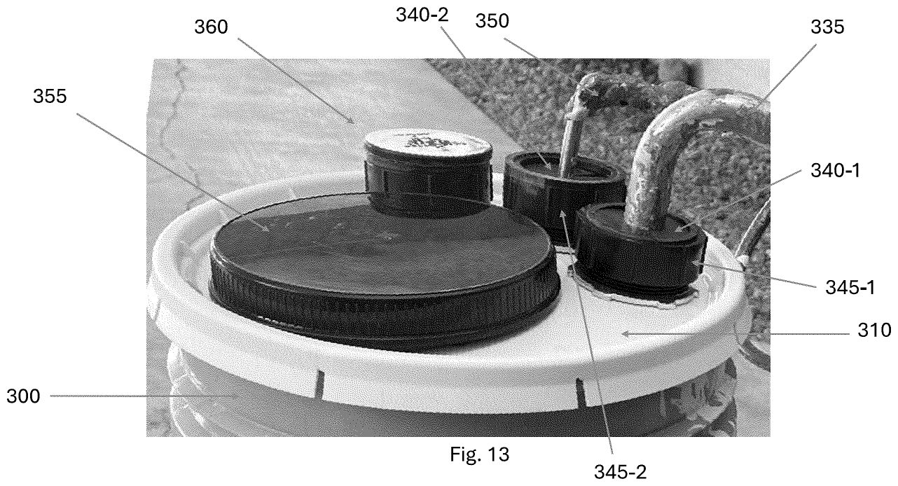

FIG. 11 shows a split rubber stopper 340-3 inserted into vent opening 315-1 and cap 355 (best seen in FIG. 12) placed over opening 320. FIG. 12 shows a cap 360 threaded onto raised rim 325-1. FIG. 13 shows a perspective top down view of the paint sprayer system in final form. The paint sprayer system of FIG. 13 does not include a vent opening. In this configuration, the paint sprayer system is ready to operate.

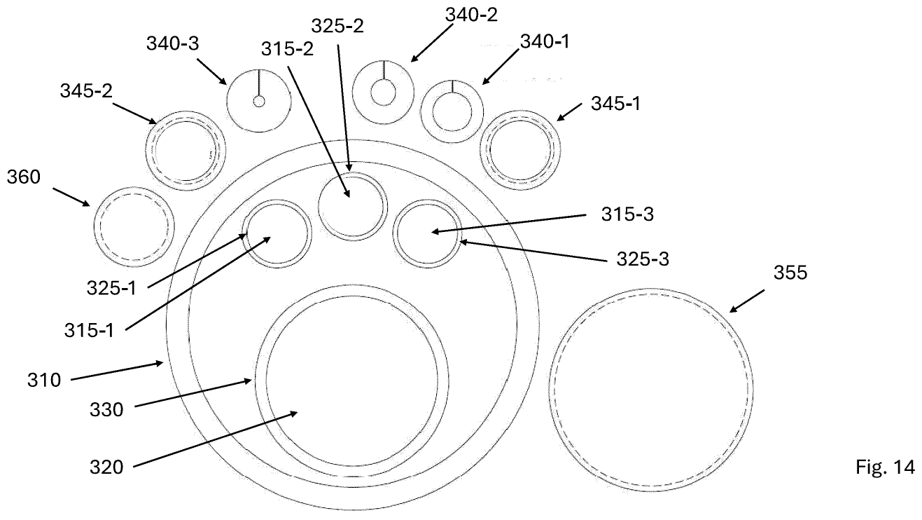

FIG. 14 shows a parts list for assembling the paint sprayer system lid 310. The lid 310 includes the openings 315-1 through 315-3 and a larger opening 320. The parts comprise raised rims 325-1 through 325-3 and 330, split rubber stoppers 340-1 through 340-3, locking caps 345-1 through 345-2, cap 355 and cap 360. As used herein, a “stopper” may be any article configured to fit into a space defined by said raised rims 325-1 through 325-3 and suitable to generally seal the space. The stopper should also not interfere with attachment of locking rings to the raised rims.

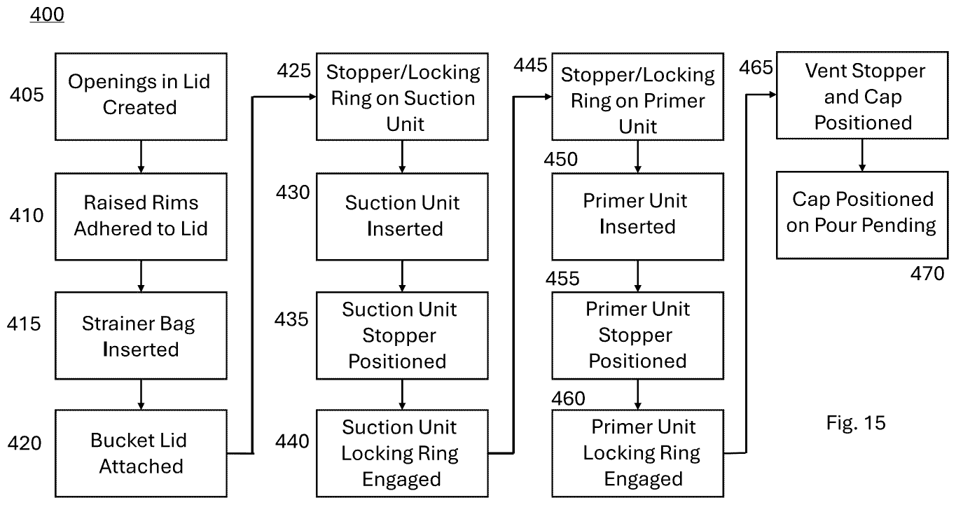

FIG. 15 shows a flow chart 400 detailing a methodology for fabricating and assembling the paint sprayer system. At 405, openings 315-1 through 315-3 and 320 are cut, punched or otherwise formed on a paint bucket lid. At 410, raised rims 325-1 through 325-1 and 330 are adhered to the lid about openings 315-1 through 315-3 and 320. The raised rims 325-1 through 325-1 and 330 may be adhered to the lid using adhesives and the like. Alternatively, raised rims 325-1 through 325-1 and 330 may be integrally formed as part of the lid by injection molding or other fabrication technique. In this embodiment, the lid and raised rims 325-1 through 325-1 and 330 are a single formed unit. At 415, a strainer bag is inserted into and attached to the bucket via an elastic band. At 420, the bucket lid is attached to the bucket. In one embodiment, the entire bucket and modified lid may be formed as a single unit by injection molding or other fabrication technique. In this embodiment, the lid, as described, is not removable. As used herein “lid” means any removable or non-removable upper/top portion of a bucket or container through which the openings, for insertion of the suction and primer units, are created.

At 425, a locking ring 345-1 and split rubber stopper 340-1 are positioned on a suction unit. At 430, the suction unit is inserted through opening 315-3 in the bucket lid and opening 307 in the strainer bag 305. At 435, the split rubber stopper 340-1 is slid down the suction unit to insulate, seal and/or cover the opening 315-3 about the inserted suction unit. At 440, the locking ring 345-1 is slid down the suction unit and threaded onto raised rim 325-3. At 445, a locking ring 345-2 and split rubber stopper 340-2 are positioned on a primer unit. At 450, the primer unit is inserted through opening 315-2 in the bucket lid and opening 307 in the strainer bag 305. At 455, the split rubber stopper 340-2 is slid down the primer unit to insulate, seal and/or cover the opening 315-2 about the inserted primer unit. At 460, the locking ring 345-2 is slid down the primer unit and threaded onto raised rim 325-2. At 465, the split rubber stopper 340-3 is positioned in vent opening 315-1 and a vent cap is threaded onto raised rim 325-1. At 470, cap 355 is positioned over paint pour opening 320. The paint sprayer system is now operational. When paint runs low, the cap 355 is removed, paint is poured into the bucket and the lid is replaced. The cap 355 may be replaced with any type of cover suitable to covering the opening 320 and preventing paint from drying in the bucket. For example, a sliding cover, magnetic cover, hinged cover, etc., may be used.

While four openings in the lid are detailed herein, those skilled in the art will recognize that greater than or less than four openings may be used. For example, the suction unit and primer unit may be inserted through a single opening in the lid. While the bucket described herein relates to a 5 gallon paint bucket, those skilled in the art will recognize that larger containers (e.g., 55 gallon containers) may benefit from the embodiments of the present invention. The paint sprayer system is also suited to spray material other than paint, such as weed killer, water, polymers and the like.

Although the invention has been described in detail with reference to several embodiments, additional variations and modifications exist within the scope and spirit of the invention as described and defined in the following claims.

I claim:

1. A sprayer system, comprising:
a container;
a container lid, said container lid including at least a suction unit opening, a primer unit opening and a pour opening, said suction unit opening for insertion of a suction unit and said primer unit opening for insertion of a primer unit, said suction unit and primer unit associated with a sprayer, said container lid further including a pour opening;
a suction unit opening raised rim circumscribing said suction unit opening;
a primer unit opening raised rim circumscribing said primer unit opening;
a suction unit stopper configured to fit around a portion of said suction unit and fit in a space defined by said suction unit opening raised ring;
a primer unit stopper configured to fit around a portion of said primer unit and fit in a space defined by said primer unit opening raised rim;
a suction unit locking ring configured to receive a portion of said suction unit and attach to said suction unit opening raised rim to maintain a suction unit inserted through said suction unit opening into said container;
a primer unit locking ring configured to receive said primer unit and attach to said primer unit opening raised rim to maintain primer unit inserted through said primer unit opening into said container; and
a cover for said pour opening.

2. The sprayer system of claim 1 wherein said sprayer is configured to spray paint.

3. The sprayer system of claim 2 wherein said container is a 5-gallon paint bucket.

4. The sprayer system of claim 1 further comprising a vent opening in said lid.

5. The sprayer system of claim 4 further comprising a vent stopper and vent cap.

6. The sprayer system of claim 1 further comprising a strainer bag configured to position in said container and attach to an upper edge thereof.

7. The sprayer system of claim 1 wherein said suction unit opening raised rim, said primer unit opening raised rim, said suction unit locking ring and said primer unit locking ring are each threaded.

8. The sprayer system of claim 1 further comprising a pour opening raised rim and pour opening cap configured to fit on said pour opening raised rim.

9. The sprayer system of claim 1 wherein said suction unit opening and said primer unit opening are the same opening.

10. A method of assembling a sprayer system, comprising:
creating in a container lid including at least a suction unit opening and a primer unit opening, said suction unit opening for insertion of a suction unit and said primer unit opening for insertion of a primer unit, said suction unit and primer unit associated with a sprayer;
creating in said container lid a pour opening;
forming a suction unit opening raised rim to circumscribe said suction unit opening; and
forming a primer unit opening raised rim to circumscribe said primer unit opening.

11. The method of claim 10 further comprising:
inserting said suction unit through a suction unit locking ring;
inserting said primer unit through a primer unit locking ring;
inserting a suction unit stopper around a portion of said suction unit and in a space defined by said suction unit opening raised rim;
inserting a primer unit stopper around a portion of said primer unit in a space defined by said primer unit opening raised rim;
inserting said suction unit through a suction unit locking ring and said suction unit opening in said container lid;
attaching said suction unit locking ring to said suction unit opening raised rim to maintain said suction unit in said container; and
attaching said primer unit locking ring to said primer unit opening raised rim to maintain said primer unit in said container.

12. The method of assembling a sprayer system of claim 11 further comprising placing a cover over said pour opening.

13. The method of assembling a sprayer system of claim 11 wherein said sprayer is configured to spray paint.

14. The method of assembling a sprayer system of claim 11 wherein said container is a 5-gallon paint bucket.

15. The method of assembling a sprayer system of claim 11 further comprising creating a vent opening in said container lid.

16. The method of assembling a sprayer system of claim 11 further comprising positioning a strainer bag in said container and attaching said strainer bag to an upper edge thereof.

17. The method of assembling a sprayer system of claim 11 further comprising threadably engaging said suction unit opening raised rim and said primer unit opening raised rim with said suction unit locking ring and said primer unit locking ring, respectively.

18. The method of assembling a sprayer system of claim 11 further comprising positioning a pour opening raised rim to circumscribe said pour opening and utilizing a pour opening cap configured to fit on said pour opening raised rim.

19. The method of assembling a sprayer system of claim 11 further comprising creating one opening for insertion of both said suction unit and said primer unit.

20. A method of using a sprayer system, comprising:
inserting a sprayer system suction unit through a suction unit locking ring;
inserting a sprayer system primer unit through a primer unit locking ring;
inserting said sprayer system suction unit into a suction unit opening in a container lid such that said suction unit is in a material to be sprayed from said container;
inserting said sprayer system primer unit into a primer unit opening in said container lid such that said primer unit is in a material to be sprayed from said container;
positioning a suction unit stopper around a portion of said suction unit and in a space defined by a suction unit opening raised rim about said suction unit opening;
positioning a primer unit stopper around a portion of said primer unit and in a space defined by a primer unit opening raised rim about said primer unit opening;
attaching said suction unit locking ring to said suction unit opening raised rim to maintain said suction unit in said container; and
attaching said primer unit locking ring to said primer unit opening raised rim to maintain said primer unit in said container.

21. The method of using a sprayer system of claim 20 further comprising placing a cover over said pour opening.

22. The method using a sprayer system of claim 20 wherein said sprayer is configured to spray paint.

23. The method of using a sprayer system of claim 20 wherein said container is a 5-gallon paint bucket.

24. The method of using a sprayer system of claim 20 further comprising covering a vent opening in said container lid.

25. The method of using a sprayer system of claim 11 further comprising positioning a strainer bag in said container and attaching said strainer bag to an upper edge thereof.

26. The method of using a sprayer system of claim 11 further comprising threadably engaging said suction unit opening raised rim and said primer unit opening raised rim with said suction unit locking ring and said primer unit locking ring, respectively.

27. The method of using a sprayer system of claim 11 further comprising inserting said suction unit and primer unit in a same opening in said container lid.
